(19) United States
(12) Patent Application Publication
(10) Pub. No.: US 2009/0070196 A1
(43) Pub. Date: Mar. 12, 2009

(54) SYSTEM AND METHOD FOR DEVELOPING SMALL GEOGRAPHIC AREA POPULATION, HOUSEHOLD, AND DEMOGRAPHIC COUNT ESTIMATES AND PROJECTIONS USING A MASTER ADDRESS FILE

(75) Inventors: James D. Shaffer, San Diego, CA (US); Eric R. Hardy, San Diego, CA (US); Kenneth L. Inman, San Diego, CA (US); Loren Jay Albertazzi, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: TARGUS INFORMATION CORPORATION, Vienna, VA (US)

(21) Appl. No.: 12/208,715

(22) Filed: Sep. 11, 2008

Related U.S. Application Data
(60) Provisional application No. 60/971,811, filed on Sep. 12, 2007.

(51) Int. Cl. G06Q 99/00; G06F 17/30

(52) U.S. Cl. 705/10

(57) ABSTRACT

In one aspect, a system and method is provided for developing small geographic area population, household, business and demographic count estimates and projections using a MAF. The systems and methods described herein use mailing addresses and corresponding address related records, in conjunction with the DPV validation and RDI coding functionality, as well as ZIP+4 type coding, in order to build a MAF with unique DPV validated addresses. Each address in the MAF is delivery point coded (DPC), mail delivery validated, has a residential/business address code, and has a USPS ZIP+4 type, FIPS code, latitude and longitude and selected demographic data. The MAF is then tabulated directly or used in conjunction with current county level or Census Bureau estimates to generate estimates of the census block records or census block group records and/or areas of any size or shape.

### RELATED APPLICATION

This application claims the benefit of U.S. Provisional Patent Applications Ser. No. 60/971,811, filed Sep. 12, 2007, entitled “SYSTEM AND METHOD FOR DEVELOPING SMALL GEOGRAPHIC AREA POPULATION, HOUSEHOLD, AND DEMOGRAPHIC COUNT ESTIMATES AND PROJECTIONS USING A MASTER ADDRESS FILE,” which is hereby incorporated by reference in their entirety.

### FIELD OF THE INVENTION

This invention relates to a system and method for developing small geographic area population, household and demographic count estimates and projections.

### BACKGROUND OF THE INVENTION

Since 1790, the United States has conducted a decennial census for various governmental needs like congressional redistricting. In the last few censuses, there have been two sets of questionnaires including the 100% and sample questionnaires. The 100% questionnaire is given to all households and their equivalents and the sample questionnaire is given to one out of six households. The most complete set of tabulated 100% questionnaire data is available in the US Census Bureaus Summary files 1 and 2 ((SF1 and SF2), while the most complete set of tabulated sample data is available in Summary file 3 (SF3). The complete list of available tables for each of the SF files is available on the US Census bureaus web site.

In the early 1970s, the results of the census were tabulated by the United States Census Bureau to various levels of geography down to the census block and made available to the public via computer tape files. The United States Census Bureau is the government agency that is responsible for the United States Census. Several private companies like CACI International, Inc. (CACI) and Urban Decision Systems (UDS) purchased these census tapes and created commercial demographic geography summary statistics products used primarily for retail site analysis. These services provided aggregated census information for various areas of various sizes or shapes anywhere in the US.

For many years, government agencies such as the United States Postal Service (USPS) with its delivery sequence file (DSF) and the U.S. Census Bureau with its master address file (MAF) have had files that are close approximations to U.S. household locations by physical address. The DSF (current version is DSF2) is a computerized file that contains all delivery point addresses serviced by the USPS, with the exception of general delivery. On the file, each delivery point is a separate record that conforms to all USPS addressing standards. Each record contains the ZIP+4 code, carrier route code, delivery sequence, delivery type, vacancy and seasonal delivery information. In general, the Census Bureau receives a delivery sequence file from the US Postal Service that it uses to locate new and problem addresses in the MAF. The Census Bureau defines a household to be an occupied housing unit. However, use of these files has been highly restricted and closely guarded within these two government entities. In the private sector companies like ADVO Inc. maintain a list of mail deliverable addresses for doing bulk occupant mailing and have contractually restricted use of this file to mailing applications.

In the late 1980s, the USPS in conjunction with the U.S. Census Bureau built a ZIP+4 to census geography correspondence file that also contained a latitude and longitude coordinate representing a ZIP+4 centroid location. They still offer a version of this file today. In addition, private companies like TeleAtlas (formerly Geographic Data Technology Inc. (GDT)) offer a quarterly updated version of this cross reference file that correlates all new postal ZIP+4 additions and changes to the current year census geography down to the census block and provides a latitude and longitude centroid for each ZIP+4. Since the US Census Geographic Base File (GBF)/Dual Independent Map Encoding (DIME) files were released with the 1970 Census, it was possible to assign a very proximal latitude and longitude to a street address using address range interpolation method based on a street segment address range and its segment end point latitude and longitudes. Initially the GBF/DIME files only covered the major metropolitan parts of the US, but today the TIGER files, which supersede DIME files, cover the entire US with a very high degree of precision, so almost any street address can be accurately coded with latitude and longitude. Today some private companies also offer exact address latitude and longitude boundaries and centroids derived from detail parcel title maps that registers near perfectly with satellite and aerial photo images. This is much more precise than the older address interpolation methods using GBF/DIME, TIGER and navigation base files that have registration inconsistencies with satellite and aerial images.

On Aug. 1, 2007, to get the cheapest bulk USPS postal rates one needs to validate all their mailing addresses against the USPS delivery point validation file (DPV) process. The DPV file or database is used for checking the validity of any known individual house, apartment, Post Office™ box, rural box (for public safety E911 reasons, the USPS is converting most RR box addresses to street addresses), mail drop, or commercial address that receives mail. The USPS updates the file used in this process monthly. This DPV functionality is now available in almost all commercial postal standardization and coding software sold by companies like Group One, Melissa Data and many others. For example, if 123 Main Street, Any Town, U.S.A. is a valid mailing address, but 125 Main Street is not, these commercial DPV validation software/USPS data packages will validate 123 Main Street, but not 125 Main Street. The USPS says there are approximately 143 million U.S. deliverable addresses, which include P.O. boxes.

The USPS also recently made available a service called residential delivery indicator (RDI), which is used to determine if a package is being shipped to a residential or business address as the shipping cost is higher for residential. The file used in this service is updated monthly. RDI is available as a USPS licensed add-on to the Group One address processing software. The use of RDI is restricted by the USPS to package delivery applications. Melissa Data has a similar software/data packaged service that is less restrictive called residential and business delivery indicator (RBDI).

Since the census occurs every 10 years, there is a need to perform current year estimates and projections for the census data by census geography. This need grows geometrically as time moves further from the most current census date and one is making multiple, million-dollar decisions based on the magnitude and quality of underlying demographic data around a potential location. Geography is a basic element of the Census Bureau's system for organizing and presenting statistical data to the public. The Census Bureau tabulates data for numerous geographic entities. The Census Bureau uses two widely known entities, States and counties, which represent the first 5 characters of the standard FIPS code as high level controls and reporting in almost all its censuses, sample surveys, and other programs. Other geographic entities, however, appear in machine-readable data summaries.

In the 70s and 80s annually updated estimates and projections were done at geographies as small as census tract by UDS, National Planning Data Corporation (NPDC), CACI and others. The updates were based on allocating higher level of geographic data from local governments and planning commissions as well as using postal delivery statistics by ZIP code and carrier route. Today these annually updated current year estimates and future year projections are commonly done at the census block group level using similar top down allocation methods without any complete and consistent national coverage, small geography population, and household information.

In 2006, Environmental Systems Research Institute (ESRI) published a white paper on using address based allocation for updates and projections. They suggest using an InfoBase file from ACXIOM that contains 111 million consumer records. This is a direct marketing/telemarketing file. It has many flaws in relation to being a current census of U.S. households. It has many out of date records, many records with partial addresses, multiple records for the same housing unit, records with P.O. box addresses, records with addresses valid to the ZIP+4 level but invalid at the individual household address, and missing records for many households. This file does provide an indication of new growth areas but has no ability to get a current accurate count of unique U.S. Census households that can be tabulated from the address level data.

With the availability of free national web based mapping systems like Google Earth and Microsoft Earth that show fairly recent small area satellite and aerial photos available for seamless panning across the entire U.S. at various zoom levels, it becomes apparent that these old allocation methods without any accurate and complete national small geography input data are not accurate for high growth, small area of geography current year estimates. Based on the value of the financial decisions made from this type of data, many developers and government entities are having people count housing units from these web based satellite and aerial photos.

Accordingly, there is a need for efficient scientific, automated and accurate bottom up approach to these estimates.

### SUMMARY

The present invention includes methods, apparatuses, and systems as described in the written description and claims. In one embodiment, a computerized method for developing small geographic area population, household, and demographic count estimates and projections includes the steps of validating a plurality of mailing addresses records against a United States Postal Service (USPS) delivery point validation (DPV) system to generate a master address file (MAF). Each address of the plurality of mailing address records is delivery point coded and includes a USPS ZIP+4 type. The method also includes processing the plurality of mailing address records of the MAF with a residential delivery indicator (RDI) service to determine if each mailing address is a residential or business address. In addition, a MAF ZIP+4 summary statistics file including a set of summary statistics records with address count of businesses, residences and of unknown addresses for each ZIP+4 is generated from the master address file. The method also includes appending one or more census block designations from a Federal Information Processing Standard (FIPS) census geography code file and associating one or more summary statistics records from the set of summary statistics records of the one or more census block designations in the MAF ZIP+4 summary statistics file. The MAF ZIP+4 summary statistics file is partitioned by census block designation. One or more census statistics records from a 100% census count block population and household statistics file are appended to the corresponding one or more summary statistics records. The census statistics records includes demographic, population and household statistics information. A census estimate for population and household based on the set of summary statistics records is generated in conjunction with generally accepted allocation techniques.

In another embodiment, a computerized system for developing small geographic area population, household, and demographic count estimates and projections is described. The system includes a master address file generation module to validate a plurality of mailing address records. The plurality of mailing address records are validated against a United States Postal Service (USPS) delivery point validation file (DPV) to generate a master address file (MAF) and process the plurality of mailing address records of the MAF with a residential delivery indicator (RDI) service to determine if each mailing address is a residential or business address. Each address of the plurality of mailing address records is delivery point coded and includes a USPS ZIP+4 type. The computerized system also includes a ZIP+4 summary statistics module to generate a MAF ZIP+4 summary statistics file from the master address file. The MAF ZIP+4 summary statistics file includes a set of summary statistics records that includes address count of businesses, residences and of unknown addresses for each ZIP+4. A ZIP+4 to census block matching module appends one or more census block designations from a Federal Information Processing Standard (FIPS) census geography code file and associates one or more summary statistics records from the set of summary statistics records to the one or more census block designation in the MAF ZIP+4 summary statistics file. The system can also include a census block tabulating module to partition the MAF ZIP+4 summary statistics file by census block designation. A census block matching module appends one or more census statistics records from a 100% census count block population and household statistics file to the corresponding one or more summary statistics records. The census statistics records including demographic, population and household statistics information. In addition, an updating module generates a census estimate for population and household based on the set of summary statistics records in conjunction with current allocation techniques.

Additionally, computerized method for providing geographic area population, household, and demographic count estimates that can be aggregated in conjunction with different sizes or shapes is described. The computerized method includes generating a census estimate for population and household based on the set of summary statistics records in conjunction with current allocation techniques. The computerized method also includes receiving a coordinate defined location from a user and retrieving census block designation record updates within the coordinate defined location from the generated census estimate. The census block designation record updates that are located within the coordinate defined location are aggregated and a result of the aggregated census block designation record updates is generated.

In yet another embodiment a computerized system for providing geographic area population, household, and demographic count estimates that can be aggregated in conjunction with different sizes or shapes is described. The computerized system also includes an updating module configured to generate a census estimate for population and household based on the set of summary statistics records in conjunction with current allocation techniques. A position receiver receives a coordinate defined location from a user and a retrieval module retrieves census block designation record updates according to the coordinate defined location from the generated census estimates. In one embodiment, an aggregating module aggregates the census block designation record updates that are located within the coordinate defined location and a publishing module generates a result of the aggregated census block designation record updates.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a system for developing small geographic area population, household and demographic count estimates and projections using a master address file (MAF) according to an embodiment;

FIG. 2 is a block diagram of a system for developing geography aggregated updates and projection for demographic characteristics according to an embodiment;

FIG. 3 is a flowchart of a method for developing small geographic area population, household and demographic count estimates and projections using a master address file (MAF) according to an embodiment;

FIG. 4 is a flowchart of a method for developing geography aggregated updates and projection for demographic characteristics according to an embodiment; and

FIG. 5 is a flowchart of a method for developing small geographic area population, household and demographic count estimates and projections using a master address file (MAF).

### DETAILED DESCRIPTION

After reading this description, it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

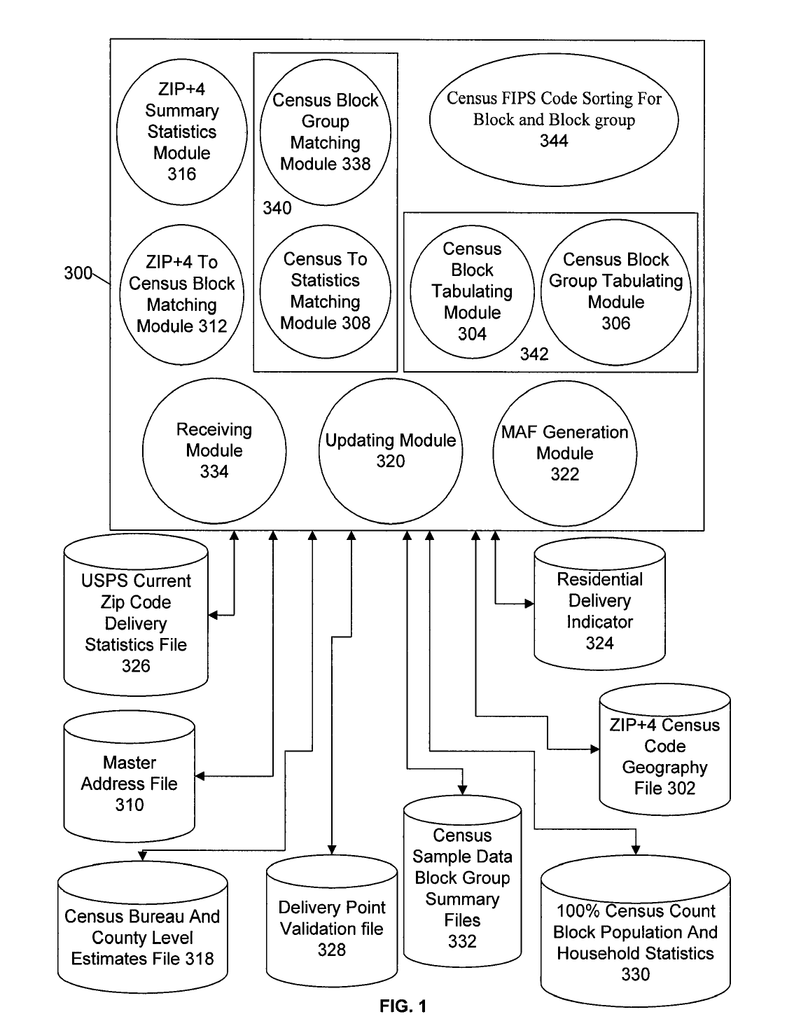

FIG. 1 is a block diagram of a system according to one embodiment of the invention. The system can be implemented on a computer system having typical computer components such as a processor, memory, storage devices, etc. FIG. 1 includes a small geographic area projection module 300 as well as a number of resources that are accessed or generated as part of the process of utilizing the small geographic area projection module 300. In the illustrated embodiment, the resources include a USPS current ZIP code delivery statistics file 326, a master address file 310, a Census Bureau and county level estimates file 318, a Delivery Point Validation (DPV) service file 328, a 100% count block population and household statistics file 330, a current census sample data block group summary files 332, a zip+4 to census code geography cross reference file 302, and an RDI service file 324.

In general, one embodiment of the small geographic area projection module 300 includes a receiving module 334, a master address file (MAF) generation module 322, a ZIP+4 summary statistics module 316, a ZIP+4 to census matching module 312, a census Federal Information Processing Standard (FIPS) code sorting for block and block group 344, a census block tabulating module 342, census block matching module 340 and an updating module 320. The census block matching module 340 includes a census block group matching module 338 and a census to statistics matching module 308. The census block tabulating module 342 include a census block code tabulating module 304 and a census block group tabulating module 306.

The receiving module 334 receives a plurality of mailing address records from feeds for both business and residential transactions. These feeds also contain data like name, telephone number, age of individuals, income, own or rent, etc. For example, there are companies such as TARGUS Information Corporation that have compiled a file of over 160 million unique consumer and business addresses including PO Boxes, all of which have been USPS DPV validated,

The MAF generation module 322 generates a MAF 310 of the plurality of mailing address records. The mailing address records can include for example, telephone numbers, type of phone wire-line or wireless, address occupant names, address type: street, highrise, PO Box etc., type of occupant: Business, Government or Residential, carrier route code, age, income, property value, geo-demographic segmentation codes, parcel latitude and longitudes. and etc. Business records can have attribute like SIC, NAICS code, number of employees, number of Yellow page ads, etc. The MAF generation module 322 can also process the plurality of addresses with a residential delivery indicator (RDI) 324 to determine if the mailing address is a residential or business address. In addition, the MAF generation module 322 validates the plurality of mailing addresses against, a United States Postal Service (USPS) delivery point validation file (DPV) 328 to determine whether a mailing address of the plurality of mailing addresses is valid. In some embodiments, the MAF generation module 322 validates the plurality of addresses against the USPS current ZIP code delivery statistics file 326 to ensure that the number of residences and businesses in the MAF match as closely as possible to the number of active deliverable residences and businesses in the USPS current ZIP code delivery statistics file 326. The Delivery statistics file provides counts of both active and potential residential and business deliverable addresses. The difference between active and potential is usually due to vacancies.

The ZIP+4 summary statistics module 316 receives the MAF 310 and generate a ZIP+4 summary statistics file. In one embodiment, the ZIP+4 summary statistics file includes an address count of businesses, residences and unknown addresses for each ZIP+4. Unknown address types are usually vacancies or not currently active addresses in terms of receiving mail.

The ZIP+4 to census block matching module 312 creates a table by matching the ZIP+4 codes of the MAF ZIP+4 summary statistics file with the ZIP+4 codes of a ZIP+4 census geography code file 302 such as FIPS census geography code file. In addition, the ZIP+4 to census block matching module 312 appends a census geography code record, for example a FIPS census geography code record, from the ZIP+4 census geography code file 302 to each of the plurality of mailing addresses in table and creates a first resultant table. The FIPS census geography code record includes a census designation code such as a census block code or a census block group. In one embodiment, the ZIP+4 to census geography code file 302 can be a TeleAtlas (GDT) file or other file having ZIP+4 code entries that can be matched to the ZIP+4 codes in the MAF ZIP+4 summary statistics file, as well as the FIPS census geography codes.

The census FIPS code sorting for block and block group 344 sorts the first resultant table by the full FIPS census block code. The census block tabulating module 304 tabulates the address counts from ZIP+4 by business/residence/unknown and by ZIP+4 type. In addition, the census block tabulating module 304 partitions the first resultant table by census block code and create a census block code record for each census block code. The census block code record can include address counts by ZIP+4 types and by the number of addresses that are businesses, residences or unknown.

The census to statistics matching module 308 receives the first resultant table that is partitioned by census block and matches each census block of the first resultant table with the census block from a current 100% census count block population and household statistics 330. This current 100% census count block population and household statistics 330 may include answers to questions that appeared on all census forms (i.e. “100% data,”) such as information about people and housing units at the state, county, municipality, and other levels, down to the block level. The census to statistics matching module 308 appends additional census block code record from the current 100% census count block population and household statistics 330 to the corresponding census block code records of the ZIP+4 summary statistics file or the corresponding first resultant derived from the MAF or ZIP+4 summary statistics file.

In one embodiment the FIPS code is a hierarchical code, for example, SSCCCTTTTTTGBBB; where SS is state, CCC is county, TTTTTT is census tract, G is block Group and BBB is block. In sorting by block using the census FIPS code sorting for block and block group 344, described above, you have automatically sorted by block group or census block group. In one embodiment, the results from appending block census characteristics from the step above are configured by tabulating the Block data to Block Group (create one record per block group) and then appending the census sample statistics available a block group to the block group tabulated file in the precious step. The census block groups include at least one census block. The census block group tabulating module 308 tabulates the address counts by census block, by business/residence/unknown and by ZIP+4 type for each census block. In addition, the census block group tabulating module 308 adds up the address counts for each census block within a census block group and associates the result with the census block group to create a census block group record for each census block group in a second resultant table. Much like the first resultant table, the second resultant table is a variation of the ZIP+4 summary statistics file that is derived from or is a variation of the MAF 310. Further, the census block group tabulating module 308 partitions the second resultant table by census block group. The census block group record including address counts by ZIP+4 types and by the number of addresses that are businesses, residences or unknown.

The census block group matching module 338 receives the second resultant table and matches each census block group with the census block group from a census sample data block group summary files 332. The census block group matching module 338 appends additional census block group record from the census sample data block group summary files 332 to the corresponding census block group record of the second resultant table. In one embodiment, the additional census block group record includes property value, age by income, own/rent and other statistics.

An updating module 320 generate estimates (or census estimates) of the census block records and/or census block group records based on the census block code records in the first resultant table and the census block group records in the second resultant table in conjunction with current county level or Census Bureau estimates for population and households. In one embodiment the estimates are generated periodically. The estimates can include estimates of population, business, household and demographic count estimates. The census estimate generated for business can be the summation of addresses in a geographic area that are identified as business addresses. The current county level or Census Bureau estimates for population and households can be acquired from the Census Bureau and County Level Estimates File 318, for example. The estimates can be short term, for example 1 year, or intermediate term, for example 5 years, estimates.

In one embodiment, a FIPS coded and precise latitude and longitude coded MAF are enhanced with individual, household and business demographic data and the individual address records are aggregated for any geography of any size or shape. In this embodiment, it may not be necessary to use upscaling or down scaling allocation methods with higher geographic level geography government estimates. In this embodiment, business estimates can be generated as there are county and city government provided business statistics. Other embodiments can be used to provide formal, complete and geographically precise as the decennial census. In addition, there a multiple conflicting definitions as to what is a business location and/or address used in these large geographic area business statistics.

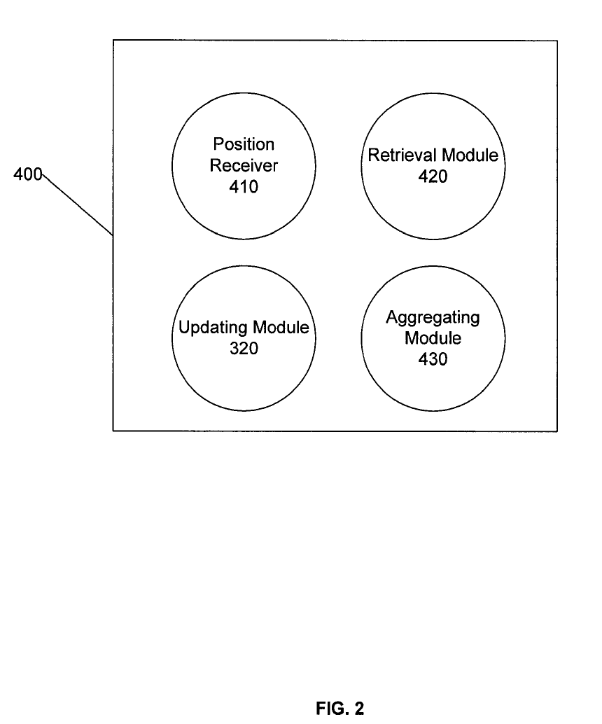

FIG. 2 is a block diagram of a geographic profile system 400 according to one embodiment of the invention. The geographic profile system 400 can be implemented on a computer system having typical computer components such as a processor, memory, storage devices, etc. FIG. 2 describes a geographic profile system 400 for providing small geographic area population, household and demographic count estimates. The estimates can be aggregated to any size or shape anywhere in the greater United States and its territories covered by the intersection of US census and the USPS postal delivery system.

In general, one embodiment of the geographic profile system 400 includes the results of updating module 320 illustrated in FIG. 1 above, a position receiver 410, a retrieval module 420 and an aggregating module 430.

As previously described, the updating module 320 uses Census Bureau and County Level Estimates File 318 and other current year county level estimates for population and households to create or generate short term and intermediate term estimates for population, households, and other characteristics at the census block and census block group level. In some embodiments, the estimates are generated periodically.

The position receiver 410 receives a coordinate defined location and a radius or a coordinate defined shape like a ZIP code boundary or an enumerated list of Census FIPS codes. In one embodiment, the coordinate defined location is a latitude and longitude defined location and a radius or a location and an inner and outer radius pair. The longitude and latitude defined shape can be a polygon or figure of any size or shape that is defined by a client/user using a number of coordinate vertices that form one or more closed boundaries that can be added together or subtracted from one another. One example is a set of islands defined as polygons like the Hawaiian Islands where the individual islands are added together to get the state total. Another example is a county in Virginia where an independent city is totally contained inside the county but is not part of the county and the city boundary tabulated data must be subtracted from the county boundary tabulated data to get the county total. One could also build a table of ZIP code updates by using the ZIP code polygon boundaries and saving the results to a file of ZIP code statistics that could later be retrieved by an enumerated list of one or more ZIP codes. ZIP codes are just one example of this as other geographic areas with boundaries like congressional districts or sales territories could also be done by this same process. Some examples of coordinate systems for generating a coordinate defined location include circular coordinate system, rectangular coordinate system, polar coordinate system, parabolic coordinate system, bipolar coordinates etc.

The retrieval module 420 retrieves census block record updates or census block group record updates that were previously generated and stored by the updating module. The retrieval module 420 can be a latitude and longitude centroid retrieval mechanism or an enumerated list of census geography codes. In one embodiment, the retrieval module 420 compares latitude and longitude centroids for each census block or census block group to the estimates calculated or generated by the updating module 320, for example. The retrieval module 420 retrieves the census block record updates or census block group record updates that correspond to the centroid values that fall within the coordinate defined location or shape such as a client defined circle or polygon.

The aggregating module 430 aggregates the retrieved census block record updates or census block group record updates that are located within the coordinate defined location or in the enumerated list. In one embodiment, the geographic profile system 400 further generates a result from the aggregated updates and publishes or provides the client or user with the result.

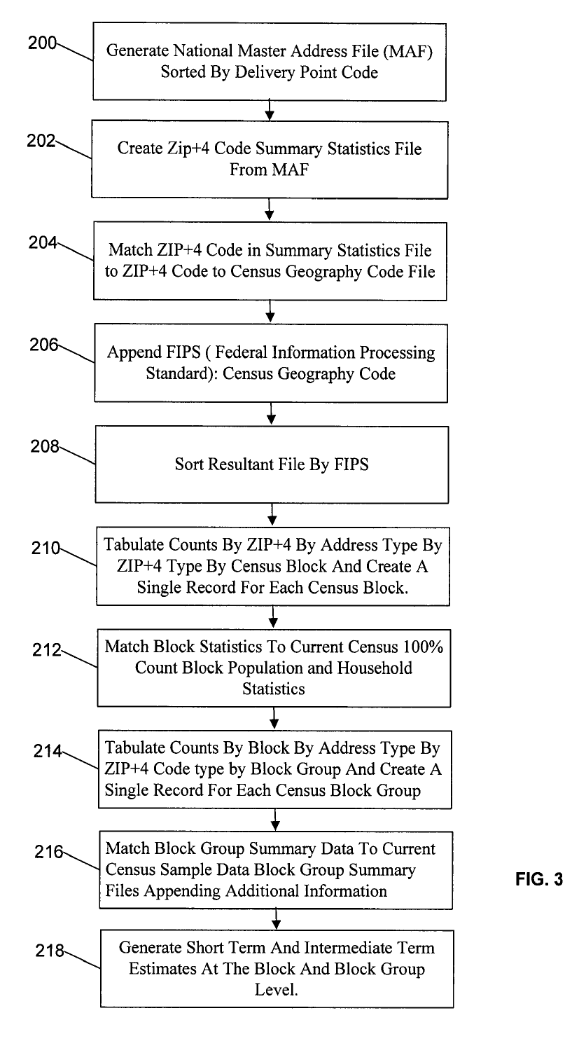

FIG. 3 is a flowchart of a method according to one embodiment of the invention. In one embodiment, the method can be implemented in the small geographic area projection module 300 of FIG. 1.

In block 200, a national master address file (MAF) 310 is generated. The steps of block 200 can be implemented in the MAF generation module 322 of FIG. 1. Generating the MAF 310 can include, for example, processing the MAF 310 with an RDI 324 to determine which entries in the MAF 310 are for residences. The completeness of the generated MAF can be checked or validated against the USPS current ZIP code delivery statistics file or USPS current ZIP code/carrier route delivery statistics file 326. In one embodiment, validation includes adding up the resident counts for each ZIP code and carrier route within ZIP code in the generated MAF 310 to ensure that it matches as closely as possible to the resident counts in the USPS current ZIP/carrier route code delivery statistics file 326. As additional data is added to the MAF like the RDI code it becomes part of the current MAF. To maintain DPV certification the addresses in the MAF can be run through DPV monthly as well as being re-RDI coded.

The generated MAF 310 can include the following fields: standardized address, city, state, full delivery point code (DPC), business/residence indicator, ZIP+4 type and carrier route. The MAF 310 can also include data from upstream source address records like consumer or business name and telephone number as well as consumer and business demographics etc. The DPC can be of the format 5-digit ZIP code, 4-digit ZIP+4, 2-digit DPC and optional check digit. The ZIP+4 type can be a street, a high-rise, a rural route, a firm, a P.O. Box or general delivery. The business residence indicator can indicate whether the address is a business, a residence, or whether it is unknown. Unknown often means that this valid address is currently vacant. The generated MAF 310 can be sorted by DPC and validated using DPV 328. In one embodiment, only validated records are used in system. The invalidated records such as valid household or business addresses where the USPS does not deliver mail may or may not be incorporated into the system depending upon other uses of the MAF 310. If the invalidated records are included in the MAF 310 they can be flagged as not validated, so they can be skipped over in specific applications.

In block 202, a ZIP+4 summary statistics file is created or generated from the MAF. The steps of block 202 can be implemented in the ZIP+4 summary statistics module 316 of FIG. 1. The ZIP+4 summary statistics file provides the number of businesses, residences, and unknown address types for each ZIP+4 (all addresses in the same ZIP+4 have the same USPS ZIP+4/address type). The ZIP+4 summary statistics file can be generated by cross tabulating counts by 9-digit ZIP code (i.e., ZIP+4) by Business/Residential address type (i.e. Residential, Business and Unknown addresses). The ZIP+4 is a hierarchical component of the DPC in the MAF 310. In one embodiment, the MAF 310 can be sorted by ZIP+4 and records in each ZIP+4 are tabulated by Business/Residential counts for each ZIP+4 type when creating the ZIP+4 summary statistics file. A 5-digit ZIP code summary statistics file can also be generated as a separate file directly or indirect from the MAF 310.

In block 204, ZIP+4 codes in the ZIP+4 summary statistics file are matched to ZIP+4 codes in a ZIP+4 to census geography code cross reference file or ZIP+4 census code geography file 302. The steps of block 204 can be implemented in the ZIP+4 to census block matching module 312 of FIG. 1. In one embodiment, a TeleAtlas (GDT) ZIP+4 to census geography code file is used and matched to the ZIP+4 entries in the MAF ZIP+4 summary statistics file. Next, in block 206, a FIPS census geography code from the census geography code file 302 or ZIP+4 census code geography file, for example, is appended to each entry in the MAF ZIP+4 summary statistics file. The steps of block 206 can be implemented in the ZIP+4 to census block matching module 312. The FIPS census geography code can be formatted as follows: SSCCCTTTTTTGBBB, where SS is a FIPS state code, CCC is a FIPS county code, TTTTTT is a FIPS census tract code, G is a FIPS census block group code, and BBB is FIPS census block code.

In block 208, the file (i.e. a modification of the ZIP+4 summary statistics file) resulting from blocks 204 and 206 is sorted by the census block code, for example, Census FIPS block code. The steps of block 208 can be implemented in the census FIPS code sorting for block and block group 344.

In block 210, the counts, for example address counts, are tabulated from ZIP+4 by business/residence address type, by ZIP+4 type and by census block to create a single record for each census block. The steps of block 210 can be implemented in the census block tabulating module 304. Each record can include a full FIPS census block designation, for example a census block code, of the form (SSCCCTTTTTTGBBB) that includes address counts by address type (i.e., street, high-rise, rural route, etc) by the number of addresses that are businesses, residences, or unknown.

In block 212, census block statistics or records of each census block are matched to current census 100% count block population and household statistics 330. The steps of block 212 can be implemented in the census to statistics matching module 308. The current census 100% count block population and household statistics 330 can include: counts by populations, age, race, household, population in group quarter counts, an urban/rural indicator, the census block's land area, and other information. Additional information from the current census 100% count block population and household statistics 330 is appended to the census block statistics or record of each census block.

In block 214, the counts are tabulated by census block by business/residential address type by ZIP+4 type by census block group, creating single record for each census block group. The steps of block 214 can be implemented in the census block group tabulating module 306. Thus, for each census block within a census block group the relevant statistics are added up and associated with the census block group in the form of a census block group record. Based on the sorting of the records by FIPS code at block 208, census block groups should be sequentially together in the resulting file or table.

In block 216, the census block group record generated in block 214 is matched to the records of the current sample census data block group summary files 332. The steps of block 216 can be implemented in the census block group matching module 338. The additional records of the current sample census data block group summary files 332 are appended to the census block group record. The additional records include, property value, age by income, own/rent and others.

In block 218, estimates of census block records and census block group records are generated in conjunction with Census Bureau and County level estimates 318 and other current year county level (from, for example, 3141 U.S. counties) estimates for population and households. The steps of block 218 can be implemented in the updating module 320. Various allocation techniques can also be implemented to create or generate short term (e.g., current year) and intermediate term (e.g., 5 year) estimates for population, households, and other characteristics at the census block and census block group level. Using county A as an example, if the US Government current year estimate for county A was 100,000 Households and the MAF active residential counts not including PO Box delivery counts totaled 98,000 and there were 2000 block groups in county A then, one household can be added to each block group estimate to match the latest county estimates. In other embodiments, allocation methods based on block group calculated growth rates, percentage of total county Households in a block group and/or other well know allocation techniques can be used. Other years could be estimated in other embodiments. For residential household estimates and projections, one embodiment only uses residential address counts for street, high-rise and rural route Box ZIP+4 types.

By summing up the counts from the above method, current year estimates by census block, census block group and county are obtained. If, for example, the present estimates for census blocks or census block groups summed to county totals are found to be 5000 households short as compared to current year county level estimates, the 5000 households can be allocated across all the census block groups. The allocation can be based on growth from the census year, population in group quarters and land area of the census block group. These census block group totals can then be allocated down to the census block level based on the same logic.

These custom geography aggregated updates and projection for demographic characteristics of FIG. 3 can be used for a variety of additional purposes as well. For example, they can be used not only for retail store location evaluation (as described above), but also for government impact studies, feasibility studies, disaster planning and recovery, utility company facilities and capacity planning, traffic network planning, political campaign planning, distribution network planning, market planning and potential estimates by geography, and providing a near census list of resident and business addresses within a custom geographic area, for example. Accurate estimates reduce investment risk, save money and allow for a more efficient deployment of limited resources.

In one embodiment, future projections can be performed by taking the growth rates between the last full census (e.g., 2000) and the current year 2007 and projecting the annual change over 5 years to 2012, for example. There can be various levels of damping or constraining based on land area and other governors. This process can be performed for all census blocks and all census block groups.

In some embodiments, where the MAF is deficient with respect to ZIP codes, the missing addresses may be acquired from various local sources and national property databases, (for example, from companies like First American and others) that can be DPV validated and classified as resident or business. Based on some restrictions, the USPS also has a program for a specific geography like a ZIP code or carrier route within a ZIP code where one can submit their near complete list of mailing addresses and the USPS will identify the ones that are invalid and add missing addresses.

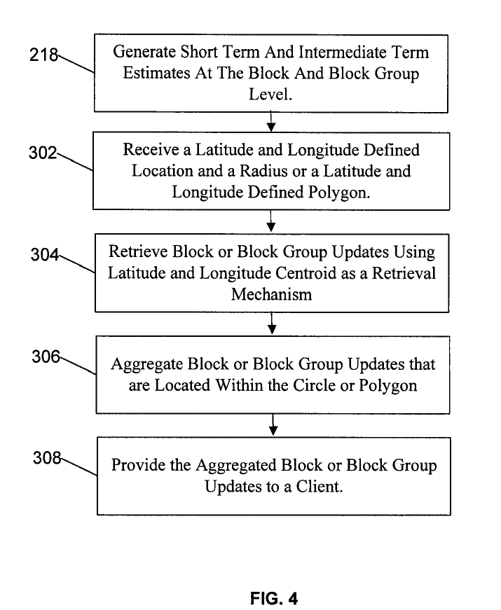

FIG. 4 is a flowchart of a method according to one embodiment of the invention. FIG. 4 describes a method for providing small geographic area population, household, and demographic count estimates. The estimates can be aggregated to any size or shape anywhere in the greater United States and its territories covered by the intersection of US census and the USPS postal delivery system.

In block 218 (as previously described), short term and intermediate term estimates are generated for population, household, and other characteristics at the census block and census block group level. The steps of block 218 can be implemented in the updating module 320 illustrated in FIG. 1 above. At block 302, a coordinate defined location/shape, for example, a latitude and longitude defined location/shape and/or a radius (e.g. a circle) is received. The steps of block 302 can be implemented in the position receiver 410. The coordinate defined location/shape may be generated in conjunction with various coordinate systems. In one embodiment, a client who subscribes to the present system can specify the coordinate defined location. The coordinate defined location can be specified using Geographic Information Systems (GIS) spatial techniques or by using other geography cross reference files related to census geography. A coordinate defined location may be a circle, polygon or similar well-known GIS figures like a band, ring, quadrant, etc. If the MAF contained precise address coordinates one could retrieve data based on the location of individual addresses to get a current household estimates for an area of any size or shape. For example, the client can be a high-end clothing company who might be evaluating a certain area to open a new store. The high-end clothing company client may define the circle or polygon based on the convenience and proximity of the store to the potential customers residing in the polygon or circle.

At block 304, census block or census block group updates are received using a latitude and longitude centroid as a retrieval mechanism. The steps of block 304 can be implemented in the retrieval module 420. A latitude and longitude centroid for each census block or census block group may be compared to the computed or generated records of block 218. The centroid values that fall within the client defined circle or polygon may be retrieved while the remaining records are not. At block 306, the retrieved records are aggregated. The steps of block 306 can be implemented in the aggregating module 430. The aggregated census block or census block group updated statistics can then be published or provided to the client in block 308. This may give the client useful information, for example, indicating the population in the area, the income for the population in the area, the demographics of the population in the area, etc. Thus, in the high-end clothing company example, the company can evaluate whether there are enough people in the area to frequent the store and whether those people are likely to be inclined to shop there and whether the people are likely to have the resources to afford the products and services offered by the clothing company. The high-end clothing company can then make a better decision as to whether the location is appropriate for their business model.

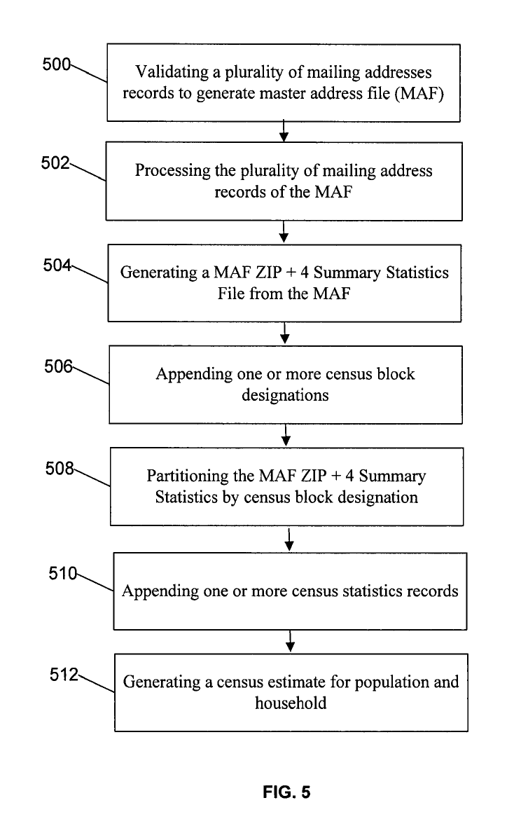

FIG. 5 is a flow chart of another embodiment of a method for developing small geographic area population, household and demographic count estimates and projections using a master address file (MAF). In one embodiment, the method can be implemented in the small geographic area projection module 300 of FIG. 1.

In block 500, a master address file 310 is generated. The steps of block 500 can be implemented in the MAF generation module 322 of FIG. 1. Generating the MAF 310 can include, for example, validating a plurality of mailing addresses records using United States Postal Service (USPS) delivery point validation (DPV) system such as a DPV certified software. Each address of the plurality of mailing address records can be delivery point coded and include a USPS ZIP+4 type. The DPV certified software can built via an API access to an encrypted database where one can build software that requires USPS certification. Using this USPS certified software, an address can be inputted in a specific form and the software can determine whether the address is USPS deliverable or not and if it is a business or residential address.

In block 502 the plurality of mailing address records of the MAF are processed with a residential delivery indicator (RDI) service to determine if each mailing address is a residential or business address. The process then continues to block 504 where a MAF ZIP+4 summary statistics file is generated from the master address file. The MAF ZIP+4 summary statistics file can include a set of summary statistics records that include address count of businesses, residences and of unknown addresses for each ZIP+4. In block 506 one or more census block designations are appended to the MAF ZIP+4 summary statistics file from a FIPS census geography code file. One or more summary statistics records from the set of summary statistics records of the one or more census block designations are associated with one or more summary statistics records from the set of summary statistics records of the MAF ZIP+4 summary statistics file.

The process then continues to block 508 where the MAF ZIP+4 summary statistics file is partitioned by census block designation. In block 510 one or more census statistics records from a 100% census count block population and household statistics file are appended to the corresponding one or more summary statistics records of the MAF ZIP+4 summary statistics file. In one embodiment the census statistics records includes demographic, population and household statistics information. In block 512 a census estimate for population and household based on the set of summary statistics records are generated in conjunction with current allocation techniques.

It should be noted that many components that are included in the elements of FIGS. 1-5 have been omitted to make the descriptions more clear. One will note that these omitted elements such as processors, network ports, memories, buses, transceivers, etc., would be included in such elements in a manner that is commonly known to those skilled in the art.

Those of skill will appreciate that the various illustrative logical blocks, modules, circuits, and algorithm steps described in connection with the embodiments disclosed herein can often be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the security beacon device, server, and sub-station and design constraints imposed on the overall system. Skilled persons can implement the described functionality in varying ways for each particular security beacon device, server, and sub-station, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), a security beacon device, server, and sub-station specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as a security beacon device, server, and sub-station specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computerized method for developing for a selected area, geographic area population, household, and demographic count estimates comprising:
validating a plurality of mailing addresses records against a United States Postal Service (USPS) delivery point validation (DPV) system to generate a master address file (MAF), each address of the plurality of mailing address records is delivery point coded and includes a USPS ZIP+4 type;
processing the plurality of mailing address records of the MAF with a residential delivery indicator (RDI) service to determine if each mailing address is a residential or business address;
generating a MAF ZIP+4 summary statistics file from the master address file, the MAF ZIP+4 summary statistics file including a set of summary statistics records that includes address count of businesses, residences and of unknown addresses for each ZIP+4;
appending one or more census block designations from a Federal Information Processing Standard (FIPS) census geography code file and associating one or more summary statistics records from the set of summary statistics records of the one or more census block designations in the MAF ZIP+4 summary statistics file;
partitioning the MAF ZIP+4 summary statistics file by census block designation; and
generating a census estimate based on the set of summary statistics records.

2. The computerized method of claim 1, further comprising appending one or more census statistics records from a 100% census count block population and household statistics file to the corresponding one or more summary statistics records, the census statistics records including demographic, population and household statistics information.

3. The computerized method of claim 1, further comprising generating a census estimate for one of population, household and business based on the set of summary statistics records in conjunction with generally accepted allocation techniques.

4. The computerized method of claim 1, wherein the census block designation is one of a census block code and a census block group.

5. The computerized method of claim 1, further comprising generating a census estimate for one of population, household and business based on the set of summary statistics records.

6. The computerized method of claim 5, wherein the census estimate generated for business comprised of summation of addresses in a geographic area that are identified as business addresses.

7. The computerized method of claim 5, further comprising adding up the address counts for each census block within a census block group and associating the result with the census block group to create a census block group record for each census block group.

8. The computerized method of claim 7, further comprising generating a current year estimate based on census block designation by summing up the counts of the census block designation records.

9. The computerized method of claim 8, further comprising generating future estimates by calculating a growth rate between the last full census and the current year estimate and projecting the annual change into the future.

10. The computerized method of claim 1, further comprising validating the master address file against a USPS current ZIP code delivery statistics file by adding up the resident counts for each ZIP code in the MAF and matching the result with the resident counts in the USPS current ZIP code delivery statistics file.

11. The computerized method of claim 10, wherein the USPS current ZIP code delivery statistics includes a resident count by 5-digit ZIP code and carrier route within the ZIP code.

12. The computerized method of claim 1, wherein the mailing address records consists of the fields selected from the group consisting of standardized address, city, state, delivery point code (DPC), business/residence indicator, ZIP+4 type and carrier route, address level longitude and latitude and current census block code.

13. The computerized method of claim 12, wherein the delivery point code is in a format selected from the group of formats consisting of 5-digit ZIP code, 4-digit ZIP+4 and 2-digit DPC.

14. The computerized method of claim 1, further comprising validating the plurality of mailing addresses against residential and business delivery indicator (RBDI) that indicates whether the address is a residence, a business or unknown.

15. The computerized method of claim 1, wherein each address of the plurality of mailing addresses comprises address level latitude and longitude.

16. The computerized method of claim 1, wherein the ZIP+4 type is selected from the group consisting of street address, high-rise address, a firm address, Post Office Box, business, residence, unknown, rural route and general delivery.

17. The computerized method of claim 1, further comprising generating a 5-digit ZIP code summary statistics file from the master address file.

18. The computerized method of claim 2, wherein the current 100% census count block population and household statistics comprises answers to questions that appeared on all census forms.

19. The computerized method of claim 18, wherein the one or more census statistics records from the current 100% census count block population and household statistics is selected from the group consisting of population counts, age counts, race counts, household counts, population in group quarter counts, urban/rural indicator counts, the census block's land area counts and other data available from US Census Bureaus Summary files 1 and 2.

20. The computerized method of claim 1, wherein the one or more census statistics records consists of records selected from the group consisting of counts associated with, property value, age by income, own/rent and other data available in US Census Bureaus Summary files 3.

21. A computerized system for developing for a selected area, geographic area population, household, and demographic count estimates comprising:
a master address file generation module configured to validate a plurality of mailing addresses records against a United States Postal Service (USPS) delivery point validation file (DPV) to generate a master address file (MAF) and process the plurality of mailing address records of the MAF with a residential delivery indicator (RDI) service to determine if each mailing address is a residential or business address, each address of the plurality of mailing address records is delivery point coded and includes a USPS ZIP+4 type;
a ZIP+4 summary statistics module configured to generate a MAF ZIP+4 summary statistics file from the master address file, the MAF ZIP+4 summary statistics file including a set of summary statistics records that includes address count of businesses, residences and of unknown addresses for each ZIP+4;
a ZIP+4 to census block matching module configured to append one or more census block designations from a Federal Information Processing Standard (FIPS) census geography code file and associating one or more summary statistics records from the set of summary statistics records to the one or more census block designation in the MAF ZIP+4 summary statistics file;
a census block tabulating module configured to partition the MAF ZIP+4 summary statistics file by census block designation; and
an updating module configured to generate a census estimate based on the set of summary statistics records.

22. The computerized system of claim 21, further comprising a census block matching module configured to append one or more census statistics records from a 100% census count block population and household statistics file to the corresponding one or more summary statistics records, the census statistics records including demographic, population and household statistics information.

23. The computerized system of claim 21, further comprising an updating module configured to generate a census estimate for one of population, household and business based on the set of summary statistics records in conjunction with generally accepted allocation techniques.

24. The computerized system of claim 21, wherein the master address file generation module is further configured to validate the master address file against a USPS current ZIP code delivery statistics file by adding up the resident counts for each ZIP code in the MAF and matching the result with to the resident counts in the USPS current ZIP code delivery statistics file.

25. The computerized system of claim 23, wherein the census estimate generated for business is the summation of addresses in a geographic area that are identified as business addresses.

26. The computerized system of claim 21, wherein the plurality of mailing address records consists of the fields selected from the group consisting of standardized address, city, state, delivery point code (DPC), business/residence indicator, ZIP+4 type and carrier route, address level longitude and latitude and current census block code.

27. The computerized system of claim 26, wherein the delivery point code is in a format selected from the group of formats consisting of 5-digit ZIP code, 4-digit ZIP+4 and 2-digit DPC.

28. The computerized system of claim 21, wherein the master address file generation module is further configured to validate the plurality of mailing addresses against residential and business delivery indicator (RBDI) that indicates whether the address is a residence, a business or unknown.

29. The computerized system of claim 21, wherein each address of the plurality of mailing addresses comprises address level latitude and longitude.

30. The computerized system of claim 21, wherein the ZIP+4 type is selected from the group consisting of street address, high-rise address, a firm address, P.O. Box, business, residence, unknown, rural route and general delivery.

31. The computerized system of claim 21, wherein the a ZIP+4 summary statistics module is configured to generate ZIP+4 summary statistics file by cross tabulating address counts by ZIP+4 code by business, residential and unknown address type.

32. The computerized system of claim 21, wherein the current 100% census count block population and household statistics file comprises answers to questions that appeared on all census forms.

33. The computerized system of claim 21, wherein the one or more summary statistics records from the current 100% census count block population and household statistics is selected from the group consisting of population counts, age counts, race counts, household counts, population in group quarter counts, urban/rural indicator counts and the census block's land area counts.

34. The computerized system of claim 22, wherein the one or more summary statistics records consists of records selected from the group consisting of counts associated with property value, age by income and own/rent.

35. A computerized method for providing geographic area population, household, and demographic count estimates that can be aggregated in conjunction with different geographic shapes comprising:
generating a census estimate for population and household based on the set of summary statistics records in conjunction with current allocation techniques receiving a coordinate defined location from a user;
retrieving census block designation record updates within a coordinate defined location from the generated census estimate;
aggregating the census block designation record updates that are located within the coordinate defined location; and
generating a result of the aggregated census block designation record updates.

36. The computerized method of claim 35, further comprising defining the coordinate defined location using longitude and latitude.

37. The computerized method of claim 35, further comprising retrieving census block designation record updates within the coordinate defined location using longitude and latitude centroids as a retrieval mechanism.

38. The computerized method of claim 35, further comprising publishing the result to a client.

39. The computerized method of claim 35, wherein the coordinate defined location is a circle or polygon.

40. A computerized system for providing geographic area population, household, and demographic count estimates that can be aggregated in conjunction with different sizes or shapes comprising:
an updating module configured to generate a census estimate for population and household based on the set of summary statistics records in conjunction with current allocation techniques;
a position receiver configured to receive a coordinate defined location from a user;
a retrieval module configured to retrieve census block designation record updates according to the coordinate defined location from the generated census estimates;
an aggregating module configured to aggregate the census block designation record updates that are located within the coordinate defined location; and
a publishing module configured to generate a result of the aggregated census block designation record updates.

41. The computerized system of claim 40, wherein the position receiver is further configured to receive a coordinate defined location that are defined by longitude and latitude.

42. The computerized system of claim 40, wherein the retrieval module is further configured to retrieve census block designation record updates within the coordinate defined location using longitude and latitude centroid as a retrieval mechanism.
